(19) United States
(12) Patent Application Publication
(10) Pub. No.: US 2008/0052381 A1
(43) Pub. Date: Feb. 28, 2008

(54) Method and system for selecting a transcoder to convert between content types

(76) Inventor: Koon Wah Yu, Brampton (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, US

(21) Appl. No.: 11/507,508

(22) Filed: Aug. 22, 2006

(51) Int. Cl. G06F 15/177; G06F 15/16

(52) U.S. Cl. 709/220; 709/248

(57) ABSTRACT

A server may provide transcoding services (e.g. to transcode Web content for mobile devices) using a plurality of transcoders. To facilitate transcoder selection, server operations may be configured using a configuration framework in which the transcoders and respective mapping priorities are specified. The framework also supports the specification of, for any of the transcoders: a) respective device profile matching data for selecting a particular transcoder in response to a requesting device's profile; and b) a respective next transcoder to invoke thereby to chain transcoder invocations. The framework may be prepared in accordance with an XML schema. The server may be a wireless gateway or proxy server for mobile devices accessing Web-based content.

### COPYRIGHT NOTICE

A portion of the disclosure of this patent document contains material which is subject to copyright protection. The copyright owner has no objection to the facsimile reproduction by any one of the patent document or patent disclosure, as it appears in the Patent and Trademark Office patent file or records, but otherwise reserves all copyright whatsoever.

### FIELD

The present application relates to the conversion of data from one content type to another and more particularly a method and system for transcoder selection where multiple transcoders may be available to transcode the same content type.

### BACKGROUND

Content in the form of data is made available on the Web in a variety of data formats or content types (e.g. HTML, CSS, javascript, SVG, XML, WML, tiff, gif, jpg, mpg, etc). However, devices requesting Web content, particularly handheld and other pervasive devices (Web-enabled cellular phones, PDAs, etc.) and more particularly those devices that communicate wirelessly with the Web, often have device or other constraints which may limit or skew preferences for the types of data the devices handle.

Transcoding technology enables the provision of content economically and efficiently to meet device constraints or other preferences. Transcoding uses specialized programs to perform conversions such as from one content type to another. For example, transcoding may be used to convert HTML for a browser to WML for a Web-enabled cellphone.

Typically, a server providing transcoding services is configured on the data network (e.g. Internet) between a data source (e.g. Web page) providing data in one content type and the requesting device (e.g. mobile device) that requires the data to be of a second content type. The server may be a wireless gateway or proxy server performing one or more other services for devices the server is assisting to communicate with the data network. The server may perform the transcoding services for a variety of types of devices. For example, the server may provide wireless gateway services to a family of handheld mobile devices. These devices may have different device capabilities such that some prefer one content type to another or are not capable of handling certain content types.

In some instances these servers are coupled to or otherwise configured with more than one transcoder. Some of the transcoders may not be capable of transcoding for specific device types serviced by the server. Sometimes two or more of the transcoders may be capable of transcoding the same content format for the server (i.e. Transcoder_A and Transcoder_B may both be capable of transcoding content format_1. Both may convert to content format_2 or one to content format_2 and the other to content format_3 that may also be acceptable for some devices.)

Further, it may be preferred to use one transcoder over another. One transcoder may be more efficient at transcoding a particular content type than another transcoder. This efficiency may result in, among other things, more accurate image depictions, reduced file sizes, reduced network load, and faster processing times. There is therefore a need for a way to configure a server to select a transcoder to convert content types.

A solution that addresses one or more of these issues is therefore desired.

### BRIEF DESCRIPTION OF THE DRAWINGS

In order that the subject matter may be readily understood, embodiments are illustrated by way of examples in the accompanying drawings, in which:

FIG. 1 is a simplified block diagram that illustrates pertinent components of an example proxy server employing transcoder selection in accordance with one embodiment, implementing priority among transcoder selection, the ability to reject profiles from selection based on device type profile, and the chaining of transcoders; and

FIG. 2 is an example XML schema for configuring transcoder selection in the server of FIG. 1;

FIG. 3 is an example of part of an XML document coded in accordance with the schema of FIG. 2; and

FIGS. 4-5 are flowcharts of operations to configure a server for selecting a transcoder and to select a transcoder when in operation in accordance with an embodiment.

### DETAILED DESCRIPTION

To facilitate transcoder selection, server operations may be configured using a configuration framework in which the transcoders and their respective mapping priorities are specified. Priority may be specified implicitly, such as by the order of the listing of the transcoders in a configuration document or explicitly, such as by assigning a specific priority.

The framework also supports the specification of, for any of the transcoders:
a) device profile matching data for selecting a particular transcoder in response to a requesting device's profile; and
b) a next transcoder to invoke thereby to chain transcoder invocations.

As well, transcoder initialization parameters may be optionally provided. The framework may be prepared in accordance with an XML schema. In examples discussed, the server may be a wireless gateway or proxy server for mobile devices accessing Web-based content.

In accordance with one aspect, there is provided a method of configuring a server to provide transcoding services. The method comprises providing a configuration framework for specifying to the server a plurality of transcoders for transcoding content types to facilitate selection of a one of the transcoders to perform the transcoding. The framework is defined for specifying for any of the transcoders a mapping priority for an input content type supported by the respective transcoder. As such, selection among transcoders capable of transcoding the input content type is responsive to the mapping priority.

The framework may be further defined for specifying for any of the transcoders device profile matching data for comparison with a device profile of a device requesting the transcoding services. As such selection of a one of the transcoders is responsive to the device profile. As well, the framework may be further defined for specifying for any the transcoders a respective next transcoder. Selection of a one of the transcoders also selects its respective next transcoder, if specified, thus chaining transcoder invocation.

The framework may also be defined for specifying for any of the transcoders an initialization parameter for configuring the initialization of the transcoder.

Preferably, the framework comprises an XML schema. Other aspects such as a computer system (e.g. server), computer program product and further methods will also be apparent.

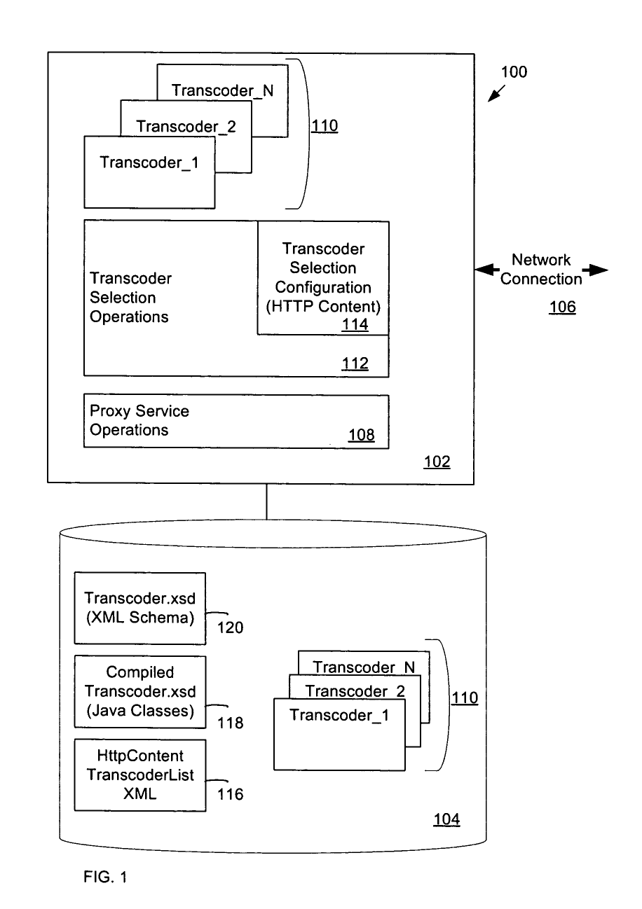

FIG. 1 is a block diagram that illustrates pertinent components of an example proxy server 100 employing transcoder selection in accordance with an embodiment. Briefly, transcoder selection operations are employed to select from a plurality (N) transcoders to perform transcoding of content (e.g. HTTP-based content) from a content source (e.g. a Web-server, not shown) for a requesting device (e.g. a wireless Web-enabled mobile device, not shown).

Persons of ordinary skill in the art will appreciate that teachings herein are applicable to servers employing transcoder selection wherein the servers communicate data between a user mobile data communication device and a content server. Though transcoding with respect to the particular flow of data from the content server to the user mobile data communication device is discussed in the examples, no limitations should be imposed as transcoding may also occur with respect to data originating from the user wireless mobile data communication device that is destined for the content server.

Proxy servers are well known in the art and persons of ordinary skill will appreciate that FIG. 1 is simplified, illustrating only representative components. There is shown RAM or other memory 102 with which to load and run software (instructions and data for configuring one or more processors (not shown) of the server). Memory 102 is coupled to a long-term storage device 104 (e.g. disk drive, etc.) for storing the software. The storage device 104 may be locally coupled as shown or remotely coupled to server 100 such as via a network connection 106. Network connection 106 also couples server 100 for communication with the requesting devices for which the server provides proxy services and, as necessary, transcoding services. Requesting devices may request content through proxy server 100 from content sources (e.g. HTTP servers (not shown)) also coupled to server 100 by network connection 106.

Memory 102 is shown comprising software for proxy service operations 108. Proxy services may include connectivity, security and authentication, caching and other services to assist requesting devices with network communications. In addition memory 102 comprises software for a plurality (N) of transcoders (collectively 110 and individually 110_1, 110_2, . . . . 110_N). Transcoders 110 each transcode content of an input content type to an output content type. The input type and output type may be the same type however, such as when scaling images or reducing colours. A transcoder may accept more than one input type for transcoding and it is also noted that two or more transcoders 110 may transcode the same input content type though not necessarily to the same output content type.

Though all N transcoders 110 are shown as loaded in memory 102, persons of skill in the art will appreciate that an individual transcoder (e.g. 110_{—}i) may be loaded as the need arises and others unloaded in accordance with memory management techniques. Transcoders 110 may be configured as plugins to the proxy services. Transcoders 110 need not be local to server 100 and may be loaded and run on another device(s) (not shown) coupled to server 100. In such a case transcoders 110 represent logical connections to the remote transcoders.

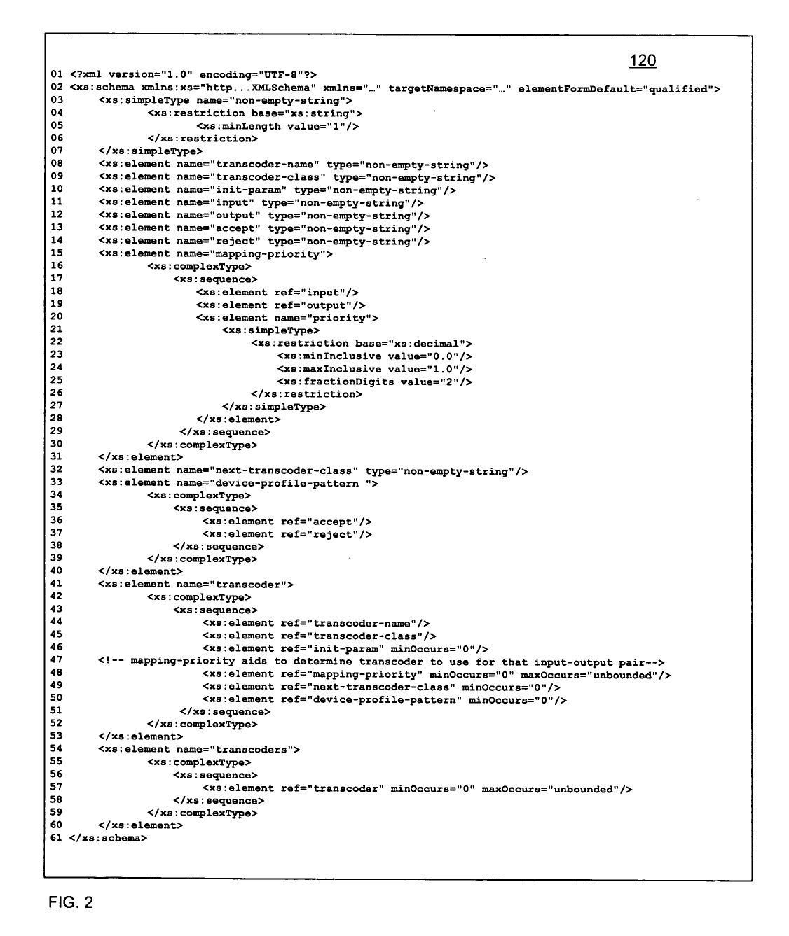

As the need for transcoding HTTP content arises, server 100 selects the appropriate transcoder 110. Memory 102 is configured with software 112 transcoder selection operations including transcoder selection configuration parameters 114. Parameters 114 are discussed further with reference to FIG. 2. Briefly, parameters 114 identify the available transcoders 110 and may identify (among other things):
selection priority among the transcoders 110 for particular input/output pairs;
whether a specific transcoder 110 accepts or rejects transcoding requests for specific device profiles; and
a next transcoder to be invoked after a specific transcoder thereby to chain specific transcoding operations.

In the present embodiment, transcoding selection parameters 114 are generated during a set-up phase of memory 102 from an Extensible Mark-up Language (“XML”) document (e.g. HttpContentTranscoderList.xml 116). The XML file may be loaded using compiled Java® classes 118 generated from an XML schema 120 (e.g. transcoder.xsd). XML configuration of software per se is well known and routine aspects thereof will not be discussed further. Though shown stored in storage 104, persons of ordinary skill will appreciate that the XML 116 and Java classes 118 were loaded in memory 102 during the set-up phase. The software of operations 108 and 112 was also loaded into memory 102 from a store (not shown), which could be store 104. Loading the configuration information in this manner allows for selection decisions to be made (e.g. comparing the data type of input or output data against the various content types accepted by transcoders that are available to perform transcoding on the server) without having to read the configuration file from storage 104 each time a comparison is needed.

FIG. 2 illustrates a representative XML schema, transcoder.xsd 120. Portions (e.g. names space references) not relevant to the teaching hereof have been omitted. Elements of the XML schema will be discussed with reference to its lines numbered 1-61.

As well as configuring transcoder selection parameters, the configuration framework of the schema 120 provides a placeholder for each of the transcoders 110 to use an initialization string for its own configuration on loading and each may specify its own format. Configuration of the XML file 116 in accordance with the schema 120 and the requirements of each of the transcoders 110 may be performed by an administrator or other technicians for proxy server 100 as is well-known. Schema notes are as follows.

For the sake of code simplicity, an empty element is not allowed (Line 3). The transcoder-name element is mainly for information purposes. Its value need not have any effect (Line 8).

The transcoder-class element specifies the suffix of the fully qualified transcoder Java class name (Line 9). The suffix may identify what content type can be transcoded by the transcoder. The init-param element specifies a configuration string for each individual transcoder. The format is of the string is up to each transcoder implementation (Line 10).

The input and output elements specify respectively the input and output media types (i.e. content type) of the transcoder mapping (Lines 11-12). It could be “*/*” for a wildcard match for an output type.

The accept element specifies device profile matching data preferably as a regular expression used to match against the device profile sent in a device content request (e.g. HTTP(S) GET) (Line 13). If a match is found, this transcoder can support requests from devices having this profile. Device profiles are often used to identify device types, specifying device requirements. Though not illustrated, proxy and transcoding operations may be further configured in response to device profiles to specify how proxy and/or transcoding operations are to be performed. The reject element specifies device profile matching data preferably as a regular expression used to match against the device profile sent in a device HTTP(S) GET request (Line 14). If a match is found, this transcoder will not be used for this device request. Thus the configuration framework is defined for specifying device profile matching data so that selection of a one of the transcoders can be responsive (either accepting or rejecting) a request in view of the device profile of the device making the request.

The mapping-priority element specifies a priority for the transcoder for the input content type (Lines 15-31). If there is more than one transcoder defined in the XML document that supports the same input content type, selection of a one of the transcoders for invocation will be responsive to the mapping priority. Priority in this embodiment is defined as a non-negative decimal number, e.g. 0.0, 0.3, or 1.0. If the highest priorities are the same, the last transcoder defined in the XML document will be used. If the priority is 0.0, it means that the transcoder will not be invoked to transcode the input content type. If no mapping priority is specified, a default value may be applied.

The next-transcoder-class specifies the next transcoder to be invoked after the selected transcoder (Line 32) effectively chaining transcoder operations together.

The device profile pattern specifies the regular expressions used to accept and reject the device request (Lines 33-40). A transcoder element consists of a sequence of transcoder-name, transcoder-class, optional init-param, optional mapping-priority, optional next-transcoder-class, optional device-profile-pattern (Lines 41-53).

Lines 54-60: The root element transcoders consists of a sequence of transcoder elements.

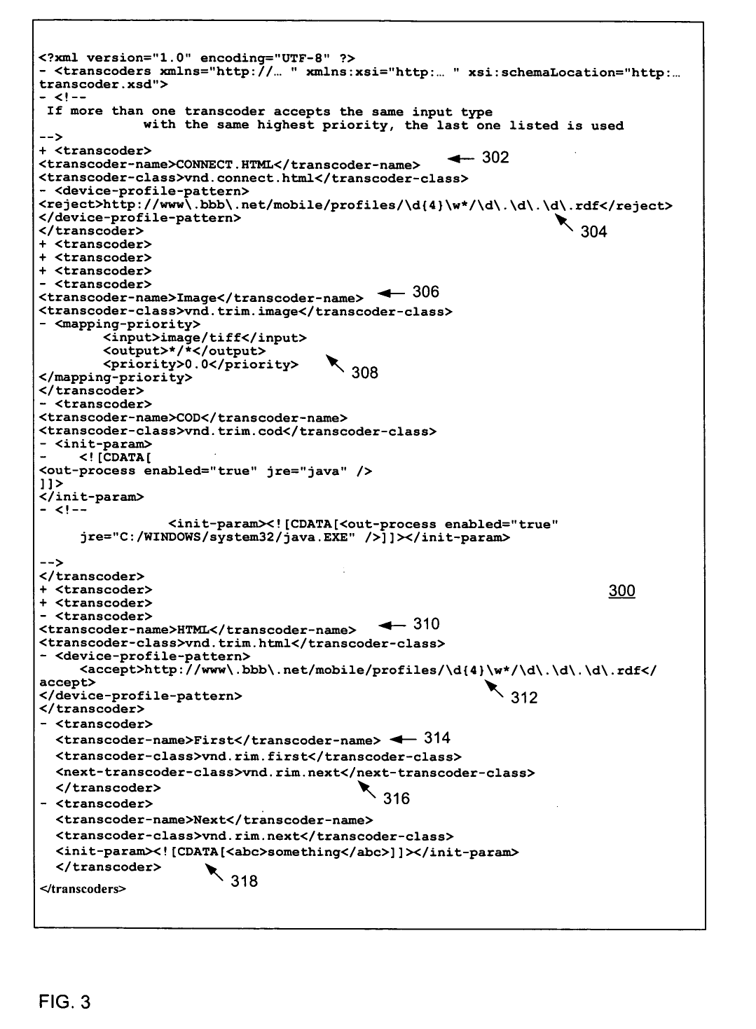

FIG. 3 illustrates an extract of an XML file 300 in accordance with the schema 120. For example, the configurations provide for a transcoder named CONNECT.HTML 302. The transcoder 302 has a reject device profile pattern 304. If a device profile URL provided with a content request to proxy server 100 (e.g. an HTTP GET) in accordance with a device/proxy protocol matches the expression pattern 304 (e.g. http://www.bbb.net/mobile/profiles/7290/4.1.0.rdf), the transcoder 302 would not be used. According to mapping priority configurations 308 for transcoder name Image 306, that transcoder would not be used to transcode TIFF data format images since the priority is 0.0.

However, if a device profile URL is http://www.bbb.net/mobile/profiles/7290/4.1.0.rdf, the transcoder HTML 310 might be used since the profile URL matches its “accept” regular expression pattern 312. Transcoder First 314 illustrates a chaining to another transcoder 316. Initialization parameters (e.g. 318) may take a CDATA format to include XML tags not defined in the schema 120 for initializing the specific transcoder.

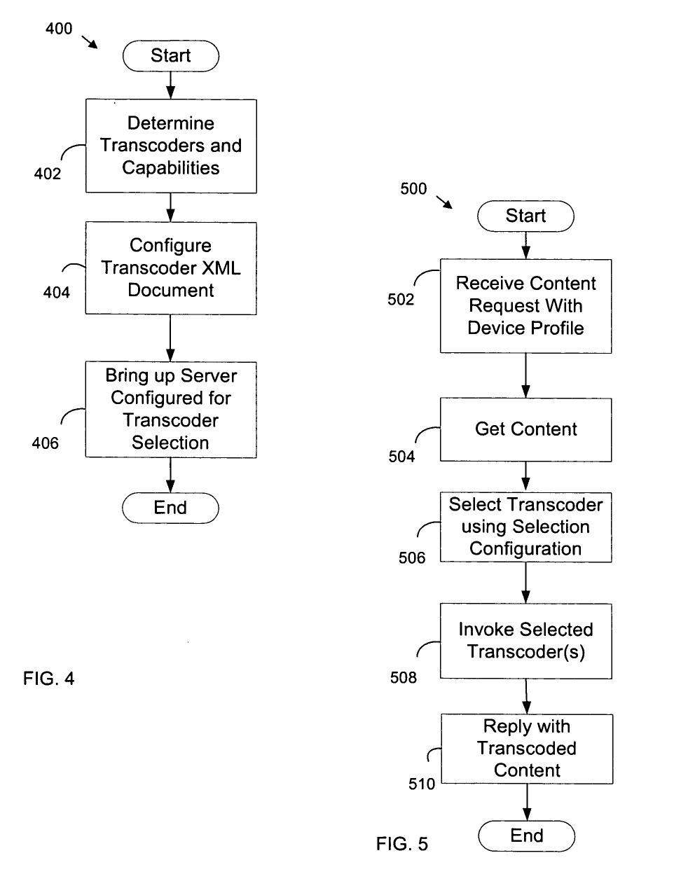

FIG. 4 illustrates operations 400 to configure a proxy server 100 for transcoder selection in accordance with an embodiment. At step 402, available transcoders and their respective capabilities are determined. At step 404, XML document 116 is configured (i.e. edited with an XML editor (not shown) to specify the required configuration data). Persons of skill in the art will appreciate that with the configuration framework described (e.g. as embodied in schema 120), there is flexibility in how the XML document may be coded. The order in which the transcoders are specified is not material except as between transcoders for the same input content type and having the same priority. Thus ordering the listing of transcoders or specifying a priority or both may be used to indicate which transcoder is to be selected. Initialization parameters may be specified. Device profile expressions may be coded to accept or reject a transcoding operation for specified device types, etc. Though steps 402 and 404 are shown as distinct steps, operations in practice may overlap or cycle. Coding of XML document 116 may be performed by a server administrator or other technician on a computing device other than server 100 (not shown) and the document 116 copied to the server 100.

At step 406, the server 100 is loaded with the software discussed previously (among other software as desired) and brought on-line ready for proxy and transcoding services. When server 100 is started, the configuration data from the XML document 116 are loaded in accordance with the various instantiated objects as determined by the compiled XML schema 120. Initialization may be delayed as described below.

Operations to code the XML schema and compile it for loading the XML document for a particular server may be performed on a different computing device (e.g. a technicians work station, PC or laptop, (not shown)) than server 100. As well, changes may be made to the XML document, and the server restarted to reload the new configuration set forth in that XML document, as desired, such as when new transcoders or device types are added.

FIG. 5 is a flowchart of operations 500 of server 100 showing an instance of simplified proxy services with transcoding. At step 502, server 100 receives a content request with a device profile URL. At step 504, server 100 gets the content having an input content type from a content source as specified in the request. At step 506, proxy server 100 selects a transcoder in accordance with the transcoder selection configuration. The selection may be responsive to the device profile type and input content type for example. A selected transcoder may refer to a next transcoder to invoke after the invocation of the selected transcoder.

At step 508, the selected transcoder (and any linked next transcoder) are invoked to transcode the content received from the content source to an output content type. Persons of skill in the art will appreciate that loading of a transcoder 110 may be performed at his time rather than when the proxy server 100 is brought on-line Step 408.

At step 510, server 100 replies to the request of step 502 with the transcoded content.

Though a proxy server is described other servers such as a Web content server may be configured to transcode and select transcoders as described. For example, a Web server may transcode its standard content for wired devices to suitable content for mobile devices. A GET request may include a device profile to aid in the transcoding.

What is claimed is:

1. A method of configuring a server to provide transcoding services, said method comprising:
providing a configuration framework for specifying to the server a plurality of transcoders for transcoding content types to facilitate selection of a one of the transcoders to perform the transcoding, said framework defined for specifying for any of the transcoders a respective mapping priority for an input content type supported by the respective transcoder, such that selection among transcoders capable of transcoding the input content type is responsive to the respective mapping priority.

2. The method of claim 1 wherein the framework is further defined for specifying for any of the transcoders respective device profile matching data for comparison with a device profile of a device requesting the transcoding services, such that selection of a one of the transcoders is responsive to the device profile.

3. The method of claim 1 wherein the framework is further defined for specifying for any of the transcoders a respective next transcoder, such that selection of a one of the transcoders also selects the respective next transcoder for invocation next.

4. The method of claim 1 wherein the framework is further defined for specifying for any of the transcoders a respective initialization parameter for configuring the initialization of the transcoder.

5. The method of claim 1 wherein the framework comprises an XML schema.

6. A computer program product having computer readable code embodied therein, for execution by a processor for configuring a server to provide transcoding services, said computer program product comprising:
a configuration framework for specifying to the server a plurality of transcoders for transcoding content types to facilitate selection of a one of the transcoders to perform the transcoding, said framework defined for specifying for any of the transcoders a respective mapping priority for an input content type supported by the respective transcoder, such that selection among transcoders capable of transcoding the input content type is responsive to the respective mapping priority.

7. The computer program product of claim 6 wherein the framework is further for specifying any one or more of the following for any of the transcoders:
(a) respective device profile matching data for comparison with a device profile of a device requesting the transcoding services, such that selection of a one of the transcoders is responsive to the device profile;
(b) a respective next transcoder, such that selection of a one of the transcoders also selects the next transcoder for invocation next; and
(c) a respective initialization parameter for configuring the initialization of the transcoder.

8. The computer program product of claim 6 wherein the framework comprises an XML schema.

9. A method of providing transcoding services comprising:
selecting a one transcoder from among a plurality of transcoders to transcode content having an input content type, said selecting responsive to a transcoder selection configuration specifying the plurality of transcoders and for any of the transcoders a respective mapping priority for the input content type supported by the respective transcoder such that selection among transcoders capable of transcoding the input content type is responsive to the respective mapping priority.

10. The method of claim 9 wherein the transcoder selection configuration is further for specifying any one or more of the following for any of the transcoders:
(a) respective device profile matching data for comparison with a device profile of a device requesting the transcoding services, such that said step of selecting is responsive to the device profile; and
(b) a respective next transcoder, such that said step of selecting also selects the next transcoder for invocation next.

11. The method of claim 9 wherein the transcoder selection configuration is further for specifying for any of the transcoders a respective initialization parameter for configuring the initialization of the transcoder and wherein the method comprises the step of initializing the transcoders in accordance with any respective initialization parameter.

12. A computer program product having computer readable code embodied therein, for execution by a processor of a server to provide transcoding services in accordance with the method of claim 9.

13. A computer program product having computer readable code embodied therein, for execution by a processor of a server to provide transcoding services in accordance with the method of claim 10.

14. A computer program product having computer readable code embodied therein, for execution by a processor of a server to provide transcoding services in accordance with the method of claim 11.

15. A server for providing transcoding services using a plurality of transcoders, said server comprising:
(a) a processor coupled to a memory storing software for execution by the processor, said software defining:
(i) a transcoder selection configuration specifying the plurality of transcoders and, for any of the transcoders, a respective mapping priority for an input content type supported by the respective transcoder; and
(ii) transcoder selection operations responsive to said transcoder selection configuration to select a one transcoder from among the plurality of transcoders such that selection among transcoders capable of transcoding the input content type is responsive to the respective mapping priority.

16. The server of claim 15 wherein the transcoder selection configuration further specifies any one or more of the following for any of the transcoders:
(a) respective device profile matching data for comparison with a device profile of a device requesting the transcoding services, such that selection operations are responsive to the device profile; and
(b) a respective next transcoder, such that said selection operations also select the next transcoder for invocation next.

17. The server of claim 15 wherein the transcoder selection configuration further specifies for any of the transcoders a respective initialization parameter for configuring the initialization of the transcoder and wherein the server initializes the transcoders in accordance with any respective initialization parameter.

18. The server of claim 15 comprising a proxy server providing proxy services to devices on a network coupled to the server and wherein the transcoding services are providing in association with the proxy services.
